(19) United States
(12) Patent Application Publication
(10) Pub. No.: US 2016/0032826 A1
(43) Pub. Date: Feb. 4, 2016

(54) TURBOFAN AIRCRAFT ENGINE

(71) Applicant: MTU Aero Engines AG, Muenchen (DE)

(72) Inventors: Klaus Peter Rued, Groebenzell (DE); Werner Humhauser, Mossburg (DE); Hermann Klingels, Dachau (DE); Rudolf Stanka, Rattenkirchen (DE); Eckart Heinrich, Germering (DE); Hans-Peter Hackenberg, Olching (DE); Claus Riegler, Karlsfeld (DE); Erich Steinhardt, Muenchen (DE); Jochen Gier, Karlsfeld (DE); Manfred Feldmann, Eichenau (DE); Norbert Huebner, Dachau (DE); Karl Maar, Pfaffenhofen an der llm (DE); Stefan Weber, Muenchen (DE)

(21) Appl. No.: 14/450,882

(22) Filed: Aug. 4, 2014

(51) Int. Cl. F02C 3/107; F01D 21/00

(52) U.S. Cl. CPC F02C 3/107; F01D 21/003

(57) ABSTRACT

A turbofan aircraft engine has at least one stage pressure ratio is at least 1.5, and a quotient of the total blade count divided by 110 is less than a difference ([(p₁/p₂)−1]) of the total pressure ratio minus one, and the total pressure ratio is greater than 4.5, and the turbine has at least two and no more than five turbine stages; and/or a product (An²) of an exit area (A_{L}) of the second turbine and a square of a rotational speed of the second turbine at the design point is at least 4.5·10¹⁰ [in²·rpm²], and a blade tip velocity (u_{TIP}) of at least one turbine stage of the second turbine at the design point is at least 400 meters per second. A jet and method are also provided.

The present invention relates to a turbofan aircraft engine having a primary duct including a combustion chamber, a first turbine disposed downstream of the combustion chamber, a compressor disposed upstream of the combustion chamber and coupled to the first turbine, and a second turbine which has a plurality of turbine stages having rotor blades and is disposed downstream of the first turbine and coupled via a speed reduction mechanism to a fan for feeding a secondary duct. The invention further relates to a passenger jet for at least 10 passengers which has a turbofan aircraft engine of this type, as well as to a method for designing such a turbofan aircraft engine.

Today, most engines of modern passenger jets are turbofan aircraft engines. In order to increase the efficiency thereof and/or to reduce noise emission, so-called “geared turbofans” are known from in-house practice. In such geared turbofans, the fan and the turbine driving it are coupled via a speed reduction mechanism.

This provides new degrees of freedom in the design of the engine components.

### SUMMARY OF THE INVENTION

It is an object of an embodiment of the present invention to provide an improved passenger jet.

The present invention provides a turbofan aircraft engine that has a primary gas duct (hereinafter also referred to as “primary duct”) for a so-called “core flow.” The primary duct includes a combustion chamber, in which, in an embodiment, air that is drawn-in and compressed is burned together with supplied fuel during normal operation. The primary duct includes a first turbine which is located downstream, in particular immediately downstream, of the combustion chamber and which, without limiting generality, is hereinafter also referred to as “high-pressure turbine”. The axial location information “downstream” refers in particular to a through-flow during, in particular, steady-state operation and/or normal operation. The first turbine or high-pressure turbine may have one or more turbine stages, each including a rotor blade array and preferably a stator vane array downstream or upstream thereof, and is coupled, in particular fixedly connected, to a compressor of the primary duct such that they rotate at the same speed. The compressor is preferably disposed immediately upstream of the combustion change and, without limiting generality, is hereinafter also referred to as “high-pressure compressor”. The high-pressure compressor may have one or more stages, each including a rotor blade array and preferably a stator vane array downstream or upstream thereof. The high-pressure compressor, combustion chamber and high-pressure turbine together form a so-called “core engine.”

The turbofan aircraft engine has a secondary duct, which is preferably arranged fluidically parallel to and/or concentric with the primary duct. A fan is disposed upstream of the secondary duct to draw in air and feed it into the secondary duct. The fan may have one or more axially spaced-apart rotor blade arrays; i.e., rows of rotor blades distributed, in particular equidistantly distributed, around the circumference thereof. A stator vane array may be disposed upstream and/or downstream of each rotor blade array of the fan. In one embodiment, the fan is an upstream-most or first or forwardmost rotor blade array of the engine, while in another embodiment, the fan is a downstream-most or last or rearwardmost rotor blade array of the engine (“aft fan”). In one embodiment, the fan is adapted or designed to feed also the primary duct and/or is preferably disposed immediately upstream of the primary duct and/or the secondary duct. At least one additional compressor may be disposed between the fan and the first compressor or high-pressure compressor. Without limiting generality, the additional compressor is also referred hereinafter to as “low-pressure compressor.”

The fan is coupled via a speed reduction mechanism to a second turbine of the primary duct. The second turbine is disposed downstream of the high-pressure turbine and, without limiting generality, is hereinafter also referred to as “low-pressure turbine”. The second turbine or low-pressure turbine has a plurality of turbine stages, each including a rotor blade array including a plurality of circumferentially distributed rotor blades and, in an embodiment, a stator vane array which includes a plurality of circumferentially distributed stator vanes and is disposed upstream or downstream of the rotor blade array. In one embodiment, at least one additional turbine may be disposed between the high-pressure and low-pressure turbines and, in one embodiment, several or all turbine stages coupled to the fan via the speed reduction mechanism together form the second turbine or low-pressure turbine according to the present invention. In one embodiment, the fan and the low-pressure turbine may be coupled via a low-pressure shaft extending through a concentric hollow shaft that couples the high-pressure compressor and the high-pressure turbine. The speed reduction mechanism may include a transmission, in particular, a single- or multi-stage gear drive. In one embodiment, the speed reduction mechanism may have an in particular fixed speed reduction ratio of at least 2:1, in particular at least 3:1, and/or no greater than 11:1, in particular no greater than 4:1, between a rotational speed of the low-pressure turbine and a rotational speed of the fan. As used herein, a speed reduction mechanism is understood to mean, in particular, a non-rotatable coupling which converts a rotational speed of the low-pressure turbine to a lower rotational speed of the fan.

The number of all turbine stages of the second turbine, in particular of all axially spaced-apart rotor blade arrays that are coupled to the fan via the speed reduction mechanism, defines a total stage count of all turbine stages of the second turbine. The number of all rotor blades and stator vanes of all turbine stages of the second turbine together defines a total blade count of all rotor blades and stator vanes of the second turbine.

At a predetermined design point, each turbine stage of the second turbine has a (design) stage pressure ratio of the (design) pressure at the inlet to the pressure at the exit of this turbine stage. At the predetermined design point, the second turbine as a whole has a (design) total pressure ratio of the (design) pressure at the inlet of the upstreammost or first turbine stage to the (design) pressure at the exit of the downstreammost or last turbine stage of the second turbine. This (design) total pressure ratio is, in particular, equal to the product of the stage pressure ratios of all turbine stages of the second turbine.

The predetermined design point may in particular be an operating point of the turbofan aircraft engine which, in an embodiment, may be defined by a predetermined rotational speed and/or a predetermined mass flow of air through the turbofan aircraft engine and which may in particular be the so-called “redline point”; i.e., an operating point of maximum allowable rotational speed and/or maximum allowable mass flow rate, an operating point for a take-off or landing operation and/or for cruise flight.

Surprisingly, it has been found that by a certain combination of the initially substantially independent design parameters of total blade count and total pressure ratio, a particularly advantageous, in particular low-noise, efficient and/or compact turbofan aircraft engine can be designed if specific minimum values are met for both the total pressure ratio and one or more stage pressure ratios of the second turbine and if the total stage count is within a narrowly defined range.

Accordingly, in accordance with one aspect of the present invention, the second turbine of a turbofan aircraft engine is designed such that a quotient of the total blade count N_{BV} of the second turbine divided by 110, in particular divided by 100, is less than a difference of the total pressure ratio (p₁/p₂) of the second turbine minus one:

N_{BV}<110·[(p₁/p₂)−1] (1)

or respectively,

N_{BV}<100·[(p₁/p₂)−1], (1a)

where the total pressure ratio of the second turbine is greater than 4.5, in particular greater than 5:

(p₁/p₂)>4.5 (2)

or respectively,

(p₁/p₂)>5, (2a)

and at least one stage pressure ratio Π, in particular each stage pressure ratio of the second turbine is at least 1.5, in particular at least 1.6, in particular at least 1.65:

Π≧1.5 (3)

or respectively,

Π≧1.5 ∀all stages (3′)

or respectively,

Π≧1.6, in particular 1.65 (3a)

or respectively,

Π≧1.6, in particular 1.65 ∀all stages, (3a′)

and where the total stage count n_{St} of the second turbine is at least two and no greater than five, in particular no greater than four:

2≦n_{St}≦5 (4)

or respectively,

2≦n_{St}≦4. (4a)

Additionally or alternatively to such a combination of total blade count and total pressure ratio in conjunction with the consideration of limits for the total pressure ratio on the one hand and the total stage count on the other hand in accordance with the above conditions (1) through (4a), a particularly advantageous, in particular low-noise, efficient and/or compact turbofan aircraft engine can surprisingly also be designed by a certain combination of the initially substantially independent design parameters of total pressure ratio and total stage count.

Accordingly, in accordance with a further aspect of the present invention, which may be combined with the aspect described above, the second turbine of a turbofan aircraft engine may be designed such that a quotient of the total pressure ratio (p₁/p₂) divided by the total stage count n_{St} is greater than 1.6, in particular greater than 1.65:

((p₁/p₂)/n_{St}>1.6 (24)

or respectively,

((p₁/p₂)/n_{St}>1.65. (24a)

Moreover, it has been found that a particularly advantageous, in particular low-noise, efficient and/or compact turbofan aircraft engine can be designed if a parameter defined by a product of an exit area of the second turbine and a square of a rotational speed of the second turbine at the design point is not less than a certain threshold value, and if, in addition, specific minimum values are met for both the stage pressure ratio of one or more turbine stages of the second turbine and a blade tip velocity of a turbine stage, particularly of a first or last turbine stage, of the second turbine at the design point.

Accordingly, in accordance with one aspect of the present invention, the second turbine of a turbofan aircraft engine is designed such that a product of an exit area (AL) of the second turbine and a square of a rotational speed n of the second turbine at the design point; i.e., in particular, a product of the exit area and a square of the maximum allowable rotational speed nₘₐₓ, is at least 4.5·1010 [in²·rpm²] or 8065 [m²/s²], in particular at least 5·1010 [in²·rpm²] or 8961 [m²/s²]:

A·n²₍ₘₐₓ₎≧4.5·1010 [in²·rpm²] (5)

or respectively,

A·n²₍ₘₐₓ₎≧5·1010 [in²·rpm²], (5a)

where at least one stage pressure ratio Π, in particular each stage pressure ratio, of the second turbine is at least 1.5, in particular at least 1.6, in particular at least 1.65:

Π≧1.5 (3)

or respectively,

Π≧1.5 ∀all stages (3′)

or respectively,

Π≧1.6, in particular 1.65 (3a)

or respectively,

Π≧1.6, in particular 1.65 ∀all stages, (3a′)

and a blade tip velocity u_{TIP} of at least one turbine stage, particularly of the first or last turbine stage, of the second turbine at the design point is at least 400 meters per second, in particular at least 450 meters per second:

u_{TIP}≧400 [m/s] (6)

or respectively,

u_{TIP}>450 [m/s]. (6a)

As used herein, a blade tip velocity u_{TIP} of a turbine stage is understood to mean, in particular, the maximum velocity of a radially outermost tip of a blade of the rotor blade array of the turbine stage in the circumferential direction at the design point; i.e., in particular, at maximum allowable rotational speed.

When several of the above-mentioned aspects are combined; i.e., when the limits specified there are observed in combination with one another in the design, then a very advantageous, in particular low-noise, efficient and/or compact turbofan aircraft engine is obtained.

In one embodiment, a bypass area ratio

$$( \frac{{A}_{B}}{{A}_{C}} )$$

of an inlet area (AB) of the secondary duct to an inlet area (AC) of the primary duct is at least 7, in particular at least 10:

$$( \frac{{A}_{B}}{{A}_{C}} ) \geq 7 \qquad ( 7 )$$

or respectively,

$$( \frac{{A}_{B}}{{A}_{C}} ) > 10. \qquad ( 7 a )$$

As used herein, an inlet area of the primary or secondary duct is understood to mean, in particular, the flow-through cross-sectional area at the inlet of the primary or secondary duct, preferably downstream, in particular immediately downstream, of the fan and/or at the same axial position.

In one embodiment, a maximum blade diameter D_{F} of the fan is at least 1.2 m.

A turbofan aircraft engine according to the present invention may in particular be advantageously used as an engine for a passenger jet for at least 10 passengers. Accordingly, one aspect of the present invention relates to a passenger jet for at least 10 passengers, which has at least one turbofan aircraft engine as described herein and is designed or certified for a cruising altitude of at least 1200 m and/or no more than 15000 m and/or a cruising speed of at least 0.4 Ma and/or no more than 0.9 Ma.

Another aspect of the present invention relates to a method for designing a turbofan aircraft engine according to the present invention, which satisfies one or more of the aforedescribed conditions, in particular of the above equations (1) through (7).

In summary, a particularly advantageous, in particular low-noise, efficient and/or compact passenger jet or turbofan aircraft engine can be provided by selecting suitable design parameters as described above.

### BRIEF DESCRIPTION OF THE DRAWINGS

Further advantageous features of the present invention will be apparent from the dependent claims and the following description of preferred embodiments. To this end, the drawings show, partly in schematic form, in:

FIG. 1: a turbofan aircraft engine of a passenger jet according to an embodiment of the present invention;

FIG. 2: a design range according to the present invention in a diagram of a total pressure ratio and a total blade count;

FIG. 3: a design range according to the present invention in a diagram of a total pressure ratio and a total stage count;

FIG. 4: a design range according to the present invention in a diagram of a product of an exit area and a square of a rotational speed of the second turbine and a blade tip velocity; and

FIG. 5: a design range according to the present invention in a diagram of a product of an exit area and a square of a rotational speed of the second turbine and a stage pressure ratio.

### DETAILED DESCRIPTION

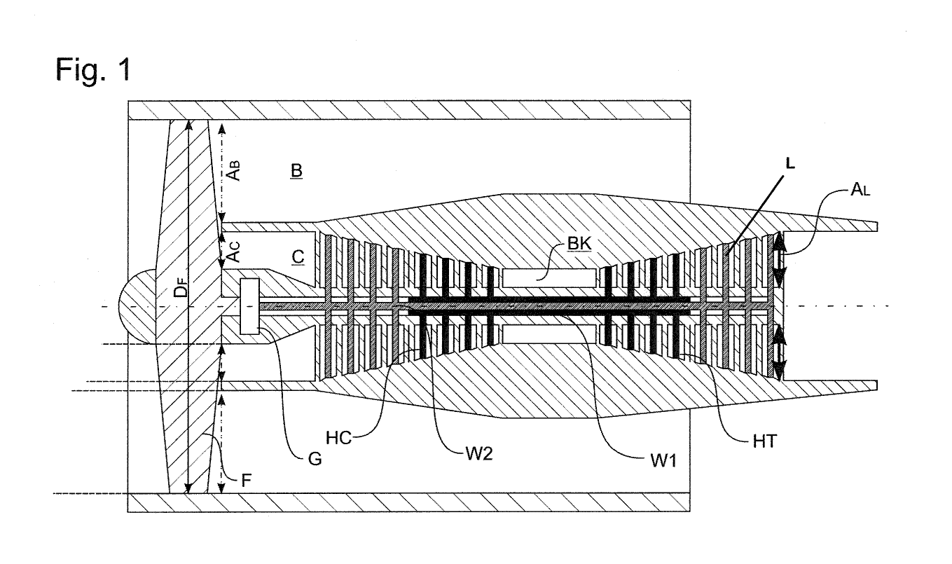

FIG. 1 depicts a turbofan aircraft engine of a passenger jet in accordance with an embodiment of the present invention, the engine having a primary duct C containing a combustion chamber BK. The primary duct has a first turbine or high-pressure turbine HT, which is located immediately downstream (to the right in FIG. 1) of the combustion chamber and includes a plurality of turbine stages. The high-pressure turbine is fixedly coupled to a high-pressure compressor HC of the primary duct via a hollow shaft W1 and, hence, such that they rotate at the same speed, the high-pressure compressor being disposed immediately upstream of the combustion chamber. As used herein, a coupling providing for rotation at the same speed is understood to mean, in particular, a non-rotatable coupling having a constant gear ratio equal to one, such as is provided, for example, by a fixed connection.

The turbofan aircraft engine has a secondary duct B, which is arranged fluidically parallel to and concentric with the primary duct. A fan F is disposed immediately upstream of the primary and secondary ducts (to the left in FIG. 1) to draw in air and feed it into the primary and secondary ducts. An additional compressor or low-pressure compressor is disposed between the fan and the high-pressure compressor.

The fan is connected through a speed reduction mechanism including a transmission G and via a low-pressure shaft W2 to a second turbine or low-pressure turbine L of the primary duct. The low-pressure turbine includes a plurality of turbine stages and is disposed downstream of the high-pressure turbine (to the right in FIG. 1). Hollow shaft W1 is concentric with low-pressure shaft W2.

A bypass area ratio

$$( \frac{{A}_{B}}{{A}_{C}} )$$

of an inlet area A_{B} of the secondary duct (indicated by a dashed line in FIG. 1) to an inlet area A_{C} of the primary duct (indicated by a dot-dash line in FIG. 1) is at least 10, and a maximum blade diameter D_{F} of the fan is at least 1.2 m.

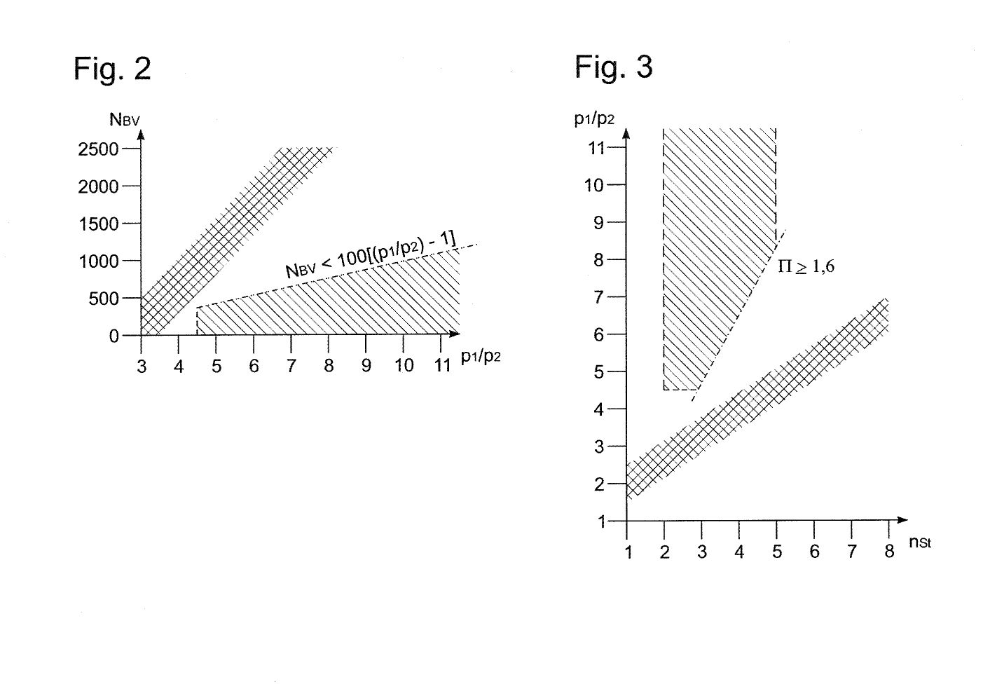

In FIG. 2, a design range according to the present invention for the turbofan aircraft engine of FIG. 1 is shown unidirectionally hatched in a diagram of a total pressure ratio (p₁/p₂) and a total blade count N_{BV} of the second turbine. For comparison, a design range according to previous in-house practice is shown cross-hatched. Similarly, in FIG. 3, a design range according to the present invention for the turbofan aircraft engine of FIG. 1 is shown unidirectionally hatched in a diagram of the total pressure ratio and a total stage count n_{St} of the second turbine. For comparison, a design range according to previous in-house practice is shown cross-hatched.

As indicated in FIG. 2 by a double-dot-dash line, the second turbine of the turbofan aircraft engine of FIG. 1 is designed such that, at a predetermined design point, especially at the “redline point” or a point of maximum allowable rotational speed and maximum allowable mass flow rate, a quotient of the total blade count N_{BV} of the second turbine divided by 100 is less than a difference of the total pressure ratio (p₁/p₂) of the second turbine minus one. In FIGS. 2 and 3, a short-dashed line indicates that the total pressure ratio of the second turbine is greater than 4.5.

As indicated in FIG. 3 by a dot-dash line, the stage pressure ratio Π of one or more, in particular all, of the turbine stages of the second turbine is at least 1.6. As indicated in FIG. 3 by a long-dashed line, the total stage count n_{St} of the second turbine is at least two and no greater than five.

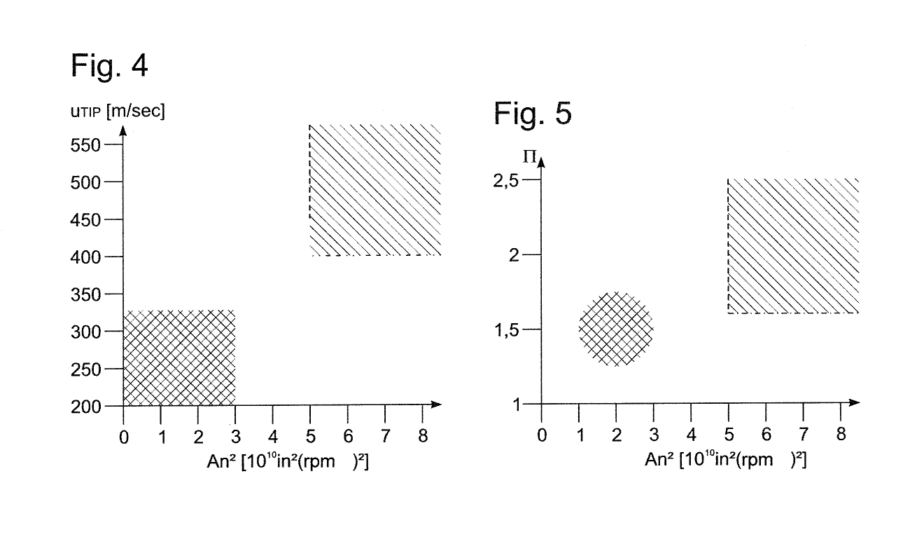

In FIG. 4, a design range according to the present invention for the turbofan aircraft engine of FIG. 1 is shown unidirectionally hatched in a diagram of a product An² of an exit area A_{L} (see FIG. 1) and a square n² of a rotational speed n and a blade tip velocity u_{TIP} of the second turbine. For comparison, a design range according to previous in-house practice is shown cross-hatched. Similarly, in FIG. 5, a design range according to the present invention for the turbofan aircraft engine of FIG. 1 is shown unidirectionally hatched in a diagram of the product An² of the exit area and the square of the rotational speed and the stage pressure ratio Π of one or more, in particular all, of the turbine stages of the second turbine. For comparison, a design range according to previous in-house practice is shown cross-hatched.

As indicated in FIGS. 4, 5 by a dashed line, the second turbine of the turbofan aircraft engine of FIG. 1 is designed such that a product An² of an exit area A_{L} of the second turbine and a square n² of a rotational speed n of the second turbine at the predetermined design point is at least 5.1010 [in²·rpm²] or 8961 [m²/s²], respectively. As indicated in FIG. 5 by a dot-dash line, the stage pressure ratio Π of one or more, in particular all, of the turbine stages of the second turbine is at least 1.6.

As indicated in FIG. 4 by a double-dash-dotted line, a blade tip velocity u_{TIP} of at least one turbine stage, particularly of the first or last turbine stage, of the second turbine at the predetermined design point is at least 400 meters per second.

Although the above is a description of exemplary embodiments, it should be noted that many modifications are possible. It should also be appreciated that the exemplary embodiments are only examples, and are not intended to limit scope, applicability, or configuration in any way. Rather, the foregoing description provides those skilled in the art with a convenient road map for implementing at least one exemplary embodiment, it being understood that various changes may be made in the function and arrangement of elements described without departing from the scope of protection set forth in the appended claims and their equivalent combinations of features.

### LIST OF REFERENCE NUMERALS

A_{B} inlet area of the secondary duct
A_{C} inlet area of the primary duct
A_{L} exit area of the low-pressure turbine
B secondary duct (bypass)
BK combustion chamber
C primary duct (core)
D_{F} maximum blade diameter of the fan
D_{L} maximum blade diameter of the low-pressure turbine
F fan
G transmission (speed reduction mechanism)
HC (high-pressure) compressor
HT first turbine or high-pressure turbine
L second turbine or low-pressure turbine
W1 hollow shaft
W2 low-pressure shaft
p₁/p₂ total pressure ratio of the second turbine
N_{BV} total blade count of the second turbine
n_{St} total stage count of the second turbine
Π stage pressure ratio of the second turbine
An² product of the exit area A_{L} of the second turbine and the square of the rotational speed n
u_{TIP} blade tip velocity of the second turbine

What is claimed is:

1. A turbofan aircraft engine comprising:
a primary duct including a combustion chamber, a first turbine disposed downstream of the combustion chamber, a compressor disposed upstream of the combustion chamber and coupled to the first turbine, and a second turbine having a plurality of turbine stages having rotor blades and disposed downstream of the first turbine and coupled via a speed reduction mechanism to a fan for feeding a secondary duct of the turbofan aircraft engine;
the second turbine having a total stage count (n_{St}) of all turbine stages of the second turbine, a total blade count (N_{BV}) of all rotor blades and stator vanes of all turbine stages of the second turbine, a stage pressure ratio (Π) of the pressure at the inlet to the pressure at the outlet at each turbine stage, and a total pressure ratio (p₁/p₂) of the pressure at the inlet of a first turbine stage to the pressure at the exit of a last turbine stage of the second turbine at a design point,
a quotient (N_{BV}/110) of the total blade count divided by 110 being less than a difference ([(p₁/p₂)−1]) of the total pressure ratio minus one, with the total pressure ratio being greater than 4.5; and
at least one stage pressure ratio is at least 1.5; and
the second turbine having at least two and no more than five turbine stages; and/or
a quotient ((p₁/p₂)/n_{St}) of the total pressure ratio divided by the total stage count being greater than 1.6.

2. The turbofan aircraft engine as recited in claim 1 wherein each stage pressure ratio is at least 1.5.

3. The turbofan aircraft engine as recited in claim 1 wherein a quotient (N_{BV}/100) of the total blade count divided by 100 is less than the difference of the total pressure ratio minus one; and/or the total pressure ratio is greater than 5; and/or at least one stage pressure ratio is at least 1.6, in particular at least 1.65; and/or the turbine has no more than four turbine stages.

4. The turbofan aircraft engine as recited in claim 3 wherein each stage pressure ratio is at least 1.6.

5. The turbofan aircraft engine as recited in claim 3 wherein at least one stage pressure ratio is at least 1.65.

6. The turbofan aircraft engine as recited in claim 5 wherein each stage pressure ratio is at least 1.65.

7. The turbofan aircraft engine as recited in claim 1 wherein a product of an exit area of the second turbine and a square of a rotational speed of the second turbine at the design point is at least 4.5·10¹⁰ [in²·rpm²], and a blade tip velocity of at least one turbine stage of the second turbine at the design point is at least 400 meters per second.

8. A turbofan aircraft engine comprising:
a primary duct including a combustion chamber, a first turbine disposed downstream of the combustion chamber, a compressor disposed upstream of the combustion chamber and coupled to the first turbine, and a second turbine having a plurality of turbine stages having rotor blades and disposed downstream of the first turbine and coupled via a speed reduction mechanism to a fan for feeding a secondary duct of the turbofan aircraft engine;
the second turbine having a total stage count (n_{St}) of all turbine stages of the second turbine, a total blade count (N_{BV}) of all rotor blades and stator vanes of all turbine stages of the second turbine, a stage pressure ratio of the pressure at the inlet to the pressure at the outlet at each turbine stage, and a total pressure ratio (p₁/p₂) of the pressure at the inlet of a first turbine stage to the pressure at the exit of a last turbine stage of the second turbine at a design point, wherein a product of an exit area of the second turbine and a square of a rotational speed of the second turbine at the design point is at least 4.5·10¹⁰ [in²·rpm²], and wherein at least one stage pressure ratio is at least 1.5, and a blade tip velocity of at least one turbine stage of the second turbine at the design point is at least 400 meters per second.

9. The turbofan aircraft engine as recited in claim 8 wherein each stage pressure ratio is at least 1.5.

10. The turbofan aircraft engine as recited in claim 8 wherein the product of the exit area of the second turbine and the square of the rotational speed of the second turbine is at least 5·10¹⁰ [in²·rpm²] and/or at least one stage pressure ratio is at least 1.6, and/or a blade tip velocity of at least one stage of the second turbine at the design point is at least 450 meters per second.

11. The turbofan aircraft engine as recited in claim 10 wherein each stage pressure ratio is at least 1.6.

12. The turbofan aircraft engine as recited in claim 10 wherein at least one stage pressure ratio is at least 1.65.

13. The turbofan aircraft engine as recited in claim 12 wherein each stage pressure ratio is at least 1.65.

14. The turbofan aircraft engine as recited in claim 1 wherein a bypass area ratio of an inlet area (A_{B}) of the secondary duct to an inlet area (A_{C}) of the primary duct is at least 7.

15. The turbofan aircraft engine as recited in claim 1 wherein a bypass area ratio of an inlet area (A_{B}) of the secondary duct to an inlet area (A_{C}) of the primary duct is at least 10.

16. The turbofan aircraft engine as recited in claim 1 wherein the maximum blade diameter of the fan is at least 1.2 m.

17. A passenger jet for at least 10 passengers comprising the turbofan aircraft engine as recited in claim 1.

18. The passenger jet as recited in claim 17 having a cruising altitude of at least 1200 m and/or no more than 15000 m and/or a cruising speed of at least 0.4 [Ma] and/or no more than 0.9 [Ma].

19. A method for designing a turbofan aircraft engine as recited in claim 1, wherein the second turbine is designed such that at least one stage pressure ratio is at least 1.5 and that a quotient (N_{BV}/110) of the total blade count divided by 110 is less than a difference ([(p₁/p₂)−1]) of the total pressure ratio minus one, with the total pressure ratio being greater than 4.5, and the turbine has at least two and no more than five turbine stages, and/or that a product (An²) of an exit area (A_{L}) of the second turbine and a square of a rotational speed of the second turbine at the design point is at least 4.5·10¹⁰ [in²·rpm²], with a blade tip velocity (u_{TIP}) of at least one turbine stage of the second turbine at the design point being at least 400 meters per second.

20. The method as recited in claim 19 wherein each stage pressure ratio is at least 1.5.
